(19) United States
(12) Patent Application Publication
(10) Pub. No.: US 2016/0060091 A1
(43) Pub. Date: Mar. 3, 2016

(54) SHROUD SYSTEM AND KIT FOR BAR GUN

(71) Applicant: Automatic Bar Controls, Inc., Vacaville, CA (US)

(72) Inventors: Thomas R. Hecht, Winters, CA (US); Richard A. Martindale, Vacaville, CA (US)

(21) Appl. No.: 14/843,906

(22) Filed: Sep. 2, 2015

Related U.S. Application Data
(60) Provisional application No. 62/044,916, filed on Sep. 2, 2014.

(51) Int. Cl. B67D 1/08; F21V 33/00; B67D 1/00

(52) U.S. Cl. CPC B67D 1/0889; B67D 1/0042; F21V 33/00

(57) ABSTRACT

A cover assembly for a bar gun with an upper elongated body having a top wall, a right side wall, a left side wall, a front wall, the upper body being shaped and adapted to contain the bar gun and to extend about and surround a nozzle extending from the bar gun. The cover assembly also has an aperture penetrating the top wall for access to buttons on the top of the bar gun.

### CROSS-REFERENCES TO RELATED APPLICATIONS

This application claims the benefit of U.S. Provisional Application No. 62/044,916, filed Sep. 2, 2014, the entire contents of which are herein incorporated by reference.

### BACKGROUND OF THE INVENTION

The invention relates to a beverage dispensing handle cover for use with a beverage dispensing system, particularly, to a cover assembly that can be installed on an existing beverage dispensing handle for modifying the look and feel of the beverage dispensing handle.

Beverage dispensing systems are commonly used in a wide variety of locales, including restaurants, snack bars, convenience stores, movie theaters, and any business where beverages are served. These beverage dispensing systems often dispense a variety of beverages of differing types and flavors, such as flavored carbonated sodas, iced tea, water, or even alcoholic beverages. .

Some beverage dispensing systems are in the form of a beverage tower while others use a beverage dispensing handle, commonly referred to as a bar gun. The bar gun uses a single nozzle for dispensing multiple different beverage depending on the needs of the end user. Most bar guns have at least one button and often numerous buttons for controlling the dispensing of a single beverage component or a mixed beverage into a container.

Bar guns are often used by an operator in preparing and mixing beverages for consumers but can also be used by consumers themselves. It is desirable for operators and establishments such as hotels, restaurants and bars, to have a more aesthetically appealing bar guns to provide a more appealing atmosphere or in some cases to provide advertisement for a particular beverage being dispensed, among other reasons.

Accordingly, it is desirable to develop a bar gun cover that can easily be installed on a bar gun to modify the look and feel of the bar gun. It is also desirable that these covers be customizable and/or provided in various shapes and configurations to meet the aesthetic requirements of those utilizing the bar guns.

### BRIEF SUMMARY OF THE INVENTION

Many embodiments are related to bar gun cover assemblies, and more specifically to bar gun cover assemblies that are configured to be installed on a pre-existing bar gun to modify the look and feel of the bar gun.

In many embodiments a cover assembly for a bar gun has an upper elongated body having a top wall, a right side wall, a left side wall, a front wall, and an open bottom, the upper body being shaped and adapted to contain the bar gun and to extend about and surround a nozzle extending from the bar gun. The cover assembly also includes and an access aperture penetrating the top wall for access to buttons on the top of the bar gun.

In many embodiments the cover assembly further includes a lower elongated body portion, configured to coordinate with the upper elongated body to form an assembly where that the body of the bar gun is contained within the assembly and the nozzle extends through the assembly. In many embodiments the assembly of the upper body and lower body is a clam shell assembly.

In many embodiments the cover assembly further includes a cover plate having at least one aperture for respective buttons on the bar gun wherein the cover plate is configured to be installed on the bar gun and is shaped to coordinate with the access aperture.

In some embodiments the cover assembly can transmit illumination throughout the cover assembly. In some aspects the cover assembly can transmit illumination to the bar gun buttons. In some aspects the cover assembly can transmit illumination to the bar gun nozzle. In some aspects can transmit illumination to the dispensed beverage.

In some embodiments the cover assembly can include illumination. In some aspects the illumination illuminates the cover assembly. In some aspects the illumination illuminates the bar gun buttons. In some aspects the illumination illuminates the bar gun nozzle. In some aspects the illumination illuminates the dispensed beverage.

Further understanding of the nature and the advantages of the embodiments disclosed and suggested herein may be realized by reference to the remaining portions of the specification and the attached drawings.

### BRIEF DESCRIPTION OF THE DRAWINGS

FIG. 1 illustrates a typical bar gun in accordance with the prior art.

FIG. 2 illustrates a front perspective view of a bar gun cover assembly in accordance with one embodiment of the present invention.

FIG. 3 illustrates a top view of the bar gun cover assembly of FIG. 2.

FIG. 4 illustrates a back perspective view of the bar gun cover assembly of FIG. 2.

FIG. 5 illustrates a front perspective view of a bar gun cover assembly in accordance with a second embodiment of the present invention with an optional plate.

FIG. 6 illustrates a top view of the bar gun cover assembly of FIG. 5.

FIG. 7 illustrates a back perspective view of the bar gun cover assembly of FIG. 5.

FIG. 8 illustrates a front perspective exploded assembly view of a bar gun cover assembly in accordance with a third embodiment of the present invention in relation to a bar gun.

FIG. 9 illustrates a side view of the bar gun cover assembly of FIG. 8 in relation to a bar gun.

FIG. 10 illustrates a bottom perspective assembled view of the bar gun cover assembly of FIG. 8 as assembled on a bar gun.

FIG. 11 illustrates a top perspective assembled view of the bar gun cover assembly of FIG. 8 as assembled on a bar gun.

### DETAILED DESCRIPTION OF THE INVENTION

Embodiments of the invention are generally directed to bar gun cover assemblies, and more specifically to a bar gun cover assembly that is configured to be installed on a pre-existing bar gun to modify the look and feel of the bar gun.

Hand held beverage dispensers, which allow an operator to dispense a number of different beverages by merely pressing an appropriate button on the dispenser, have been around for many years. One exemplary bar gun is as described in Assignees pioneering patent, U.S. Pat. No. 4,986,449 to Valiyee, the entirety of which is incorporated herein by reference. An exemplary tower is described in Assignees patent application, U.S. Application No. US2011/0315711 A1 to Hecht. Other similar bar guns and towers are commercially available from Automatic Bar Controls at www.wunderbar.com.

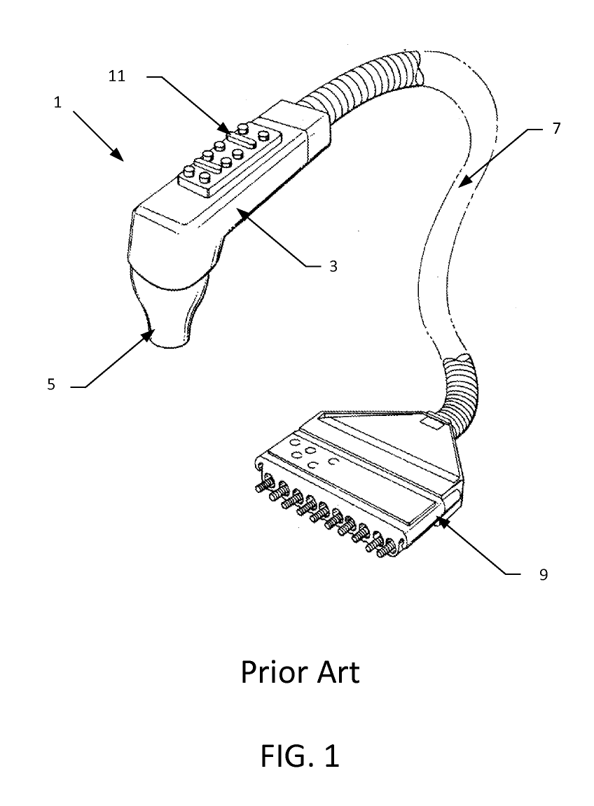

Regarding a bar gun, as seen in Valiyee and illustrated in FIG. 1, the bar gun 1 has a handle 3 that has a nozzle 5 at one end for dispensing the beverage. At the other end, the handle 3 is connected to a flexible line 7 that connects to a brixing device 9 that contains shut off and flow valves for controlling the flow of beverage components to the bar gun. The brixing device 9 is in turn connected to a beverage source (not shown). The bar gun, also has buttons 11 on the handle 3 that activate valves for dispensing a single beverage component or a mixed beverage solution depending on the button 11 pushed by the operator and the configuration of the bar gun 1.

In use, the bar gun cover assembly is installed on a bar gun like the one described above. Embodiments of bar gun covers in accordance with the present invention are configured such that i) the buttons required to operate the bar gun remain accessible, ii) the nozzle through which the beverage is dispensed is not blocked by the cover assembly and iii) an aesthetically appealing look is provided to the bar gun itself

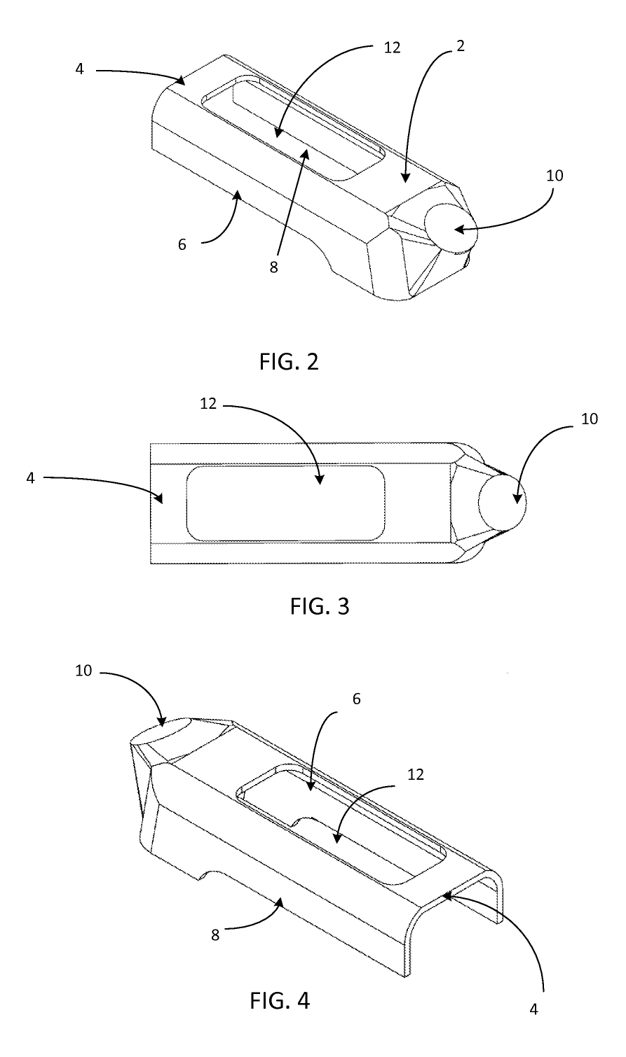

The above aspects can be further understood with reference to the exemplary devices shown in FIGS. 2-11, although the invention is not limited to the depicted embodiments and may include many variations in accordance with the principles and aspects described herein.

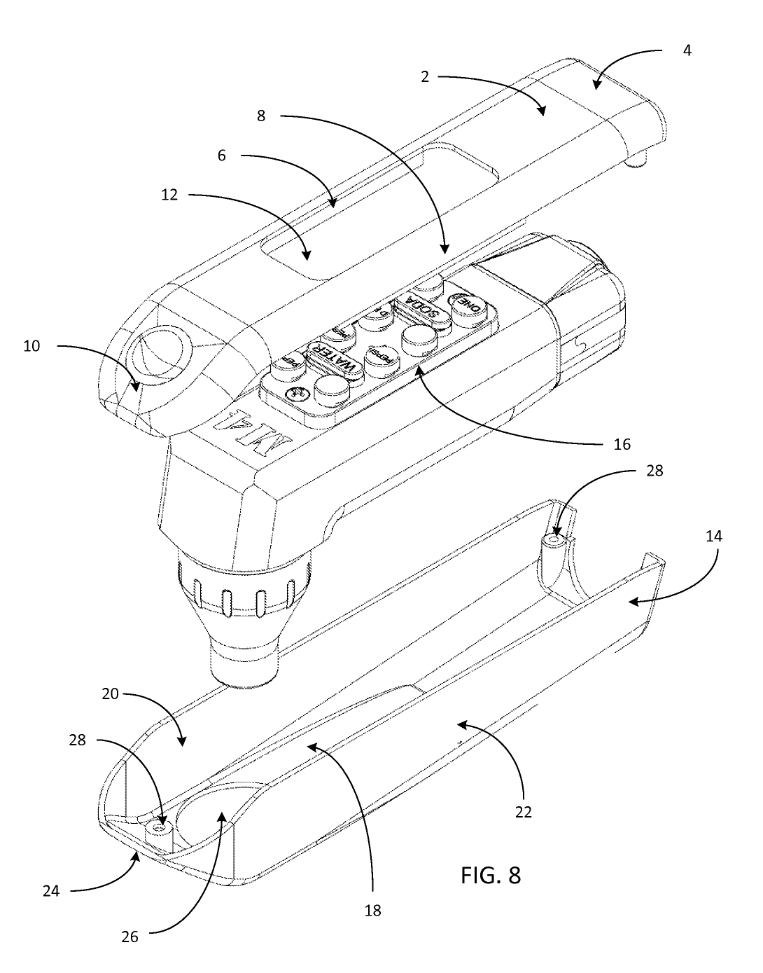

FIGS. 2-4 show perspective views and a top view of one embodiment of a cover assembly in accordance with the present invention. The cover assembly includes an elongated upper body 2. In other embodiments discussed below and illustrated in FIGS. 8-10, the upper body 2 may be used in conjunction with a lower body 14. The upper body 2 has a top wall 4 that connects a right wall 6 and a left wall 8. The upper body 2 extends along these walls and adjoins a front wall 10. The internal surface of the upper body 2 that is defined by the aforementioned walls are generally shaped to match the shape of the bar gun so that the cover can be installed and secured onto the bar gun. The bar gun cover assembly can be installed on the bar gun in various ways, including with adhesives, Velcro, snap-fit, press-fit or fasteners among other means for securing the cover assembly to the bar gun.

The external portions of the top wall 4, right wall 6, left wall 8 and front wall 10 can vary in multiple ways including shape, thickness and texture, among others, depending on the visual aesthetic and the feel that the operator wants for the bar gun.

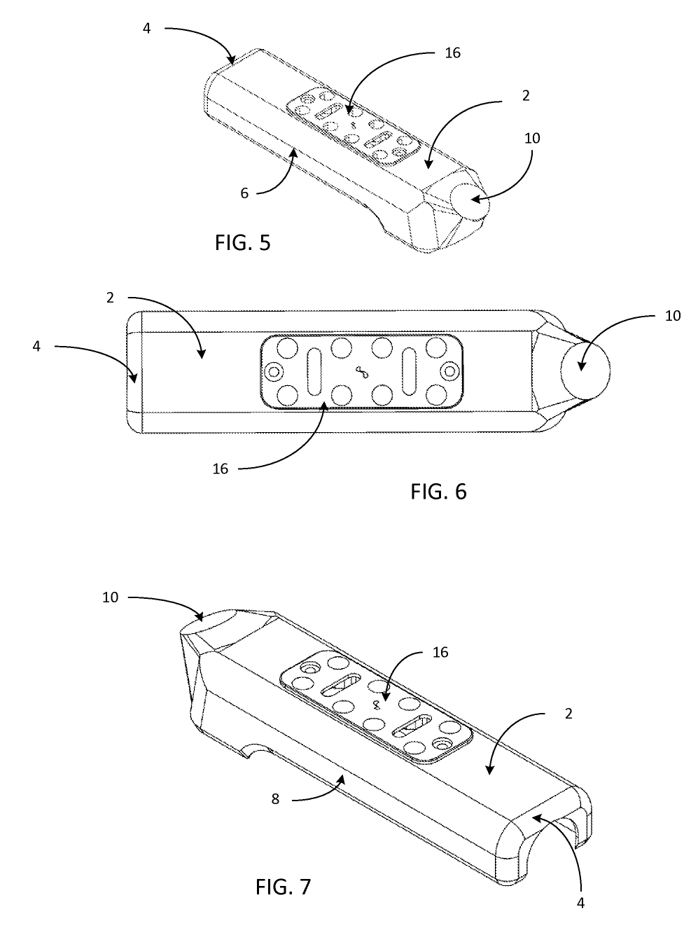

The upper body 2 has an aperture 12 that penetrates the top wall 4. This aperture 12, provides access to buttons of the bar gun that operate the dispensing of beverage fluid from the bar gun during operation, as can be seen in FIG. 11. The aperture 12 can be a single aperture that allows access to multiple buttons or the aperture could be numerous apertures each configured and co-aligning with respective buttons on the bar gun. Further still, as seen in FIGS. 5-7 a cover plate 16 having its own apertures can be installed on the bar gun with the cover plate aligning with the aperture 12 of the cover assembly providing a harmonious look between the upper body 4 and cover plate 12.

The underside of the upper body 2 is open as is the back side of the body 2. This is so the cover assembly can easily be installed on the bar gun by laying it down over the top of the bar gun or in the case of snap-fit or press-fit, pressing it onto the bar gun. The back side of the upper body 2 is open given the configuration of the bar gun and beverage fluid lines that extend from the back side of the bar gun.

The front wall 10 of the upper body 2 can be configured in various shapes to provide the cover assembly a distinct look or feel. Exemplary shapes are illustrated throughout FIGS. 2-11.

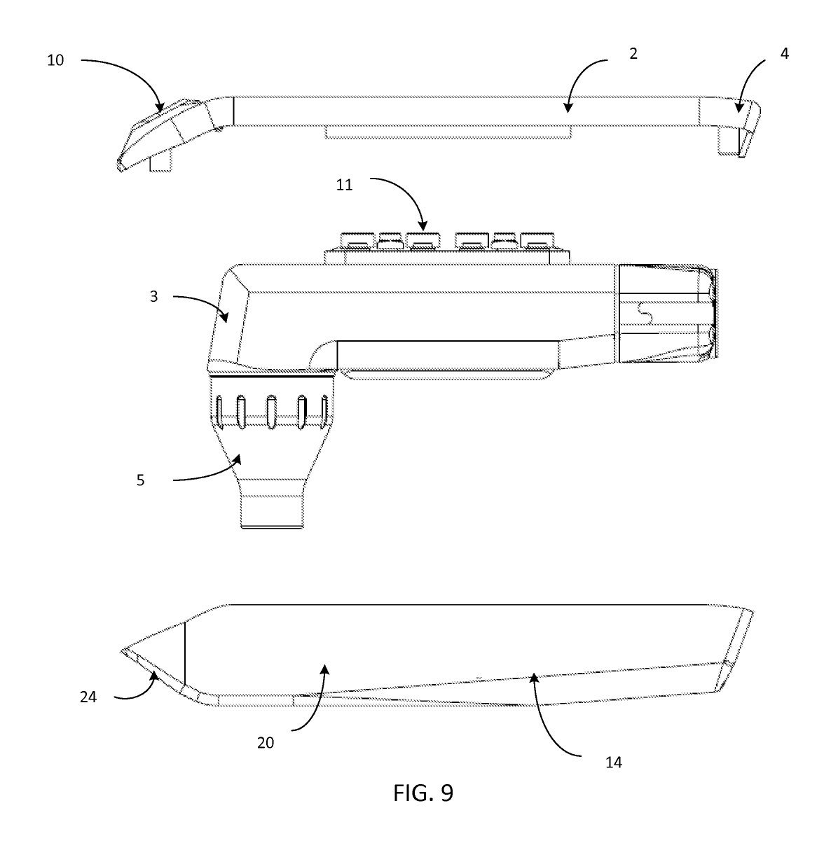

FIGS. 8 and 9 shows an embodiment where a lower body 14 is utilized in conjunction with the upper body to fully enclose the bar gun handle. In this embodiment, the lower body 14 coordinates with and adjoins with the upper body 2 to form an assembly of two pieces for the cover for the bar gun. The lower body 14 has a bottom wall 18 that connects a right wall 20 and a left wall 22. The upper body 14 extends along these walls and adjoins a front wall 24. An aperture 26 penetrates the bottom wall 18 of the lower body to accommodate the nozzle of the bar gun. The internal sides of the walls and bottom are generally shaped to match the shape of the bar gun so that the cover can be installed and secured onto the bar gun. The walls are also configured to coordinate with the upper body 2 so when both the upper body 2 and the lower body 14 are installed on the bar gun, the upper and lower body mate to form a shroud encasing the bar gun.

The upper body 2 and lower body 14 can both be placed onto the bar gun, snapped together or form a clam-shell assembly, among other ways for adjoin each piece and installing them on the bar gun. In the case where fasteners are used, fastener holes 28 penetrate the cover assembly in both the upper body 2 and lower body 14 for fastening the two pieces together as seen in FIG. 8.

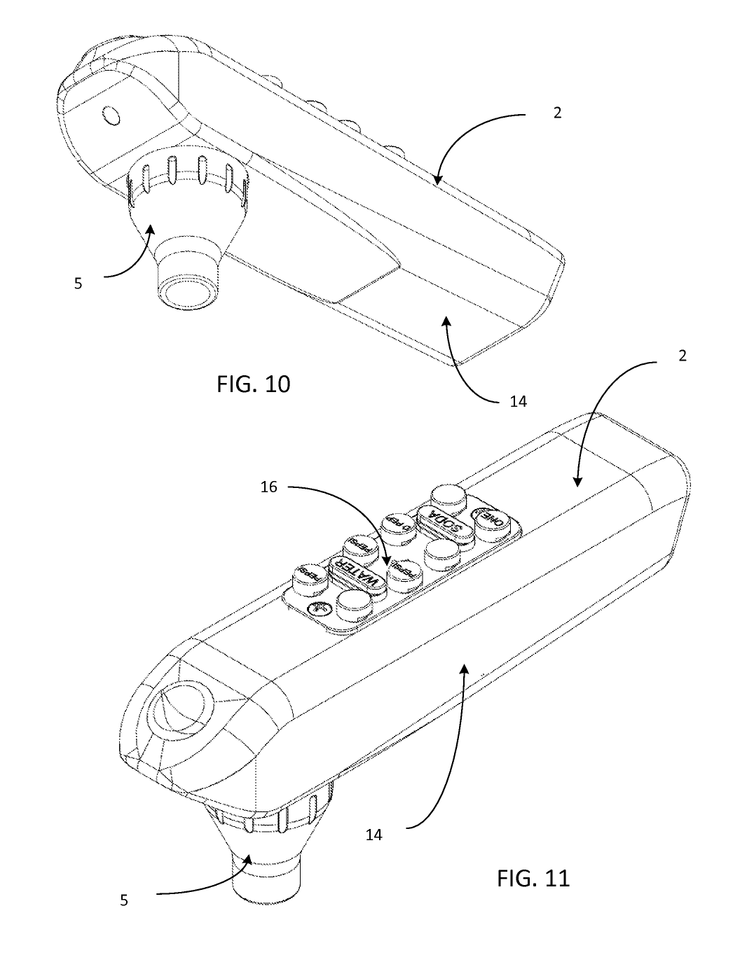

FIGS. 10 and 11 illustrate a perspective assembled view of the bar gun cover assembly described above and installed on a bar gun. The bar gun in this embodiment is completely enclosed within the cover assembly and the nozzle can be seen extending through the aperture 26 of the lower body 14 of the assembly. The buttons of the bar gun can also be seen protruding from the cover assembly thus providing a completely operable bar gun encased in a cover in design and configuration as desired by a user.

In some embodiments the bar gun cover assembly can transmit or include illumination to 1) the bar gun cover itself, 2) the buttons, 3) the nozzle, 4) the beverage flow from the nozzle or any combination of these features, among others. The illumination can be provided by LED lights, fiber optics or lasers or any other light source. Illumination can be provided constantly or in patterns and sequences. The illumination can be continually provided by direct power or also can be provided by the controller in any number of configurations or sequences to provide illumination including safety, entertainment, ease of use, beverage dispensing tracking, and aesthetics, among other uses. Suitable illumination systems useable in the covers disclosed herein can be found at U.S. Pat. Nos. 7,931,382, and 8,459,819, both of which are incorporated by reference.

The above description is illustrative and is not restrictive. A recitation of “a”, “an” or “the” is intended to mean “one or more” unless specifically indicated to the contrary. Many variations of the disclosure will become apparent to those skilled in the art upon review of the disclosure. One or more features from any embodiment described herein may be combined with one or more features of any other embodiment without departing from the scope of the disclosure. The scope of the disclosure should, therefore, be determined not with reference to the above description, but instead should be determined with reference to the pending claims along with their full scope or equivalents.

What is claimed is:

1. A cover assembly for a bar gun for dispensing a beverage, the cover assembly, comprising:
an upper body having a top wall, a right side wall, a left side wall, a front wall, the top wall, a right side wall, a left side wall, a front wall defining an exterior surface for gripping and an interior surface, the upper body being shaped and adapted to contain a handle of a pre-existing bar gun, the upper body having an access aperture penetrating the top wall for access to buttons on the top of the bar gun,
wherein the interior surface is shaped to mate to an exterior surface of the handle of the pre-existing bar gun.

2. The cover assembly of claim 1 further comprising a lower body portion, configured to coordinate with the upper body to form an assembly where that the handle of the bar gun is contained within the assembly and the nozzle extends through the assembly.

3. The cover assembly of claim 2 wherein the assembly is a clam shell assembly.

4. The cover assembly of claim 2 further comprising a cover plate having at least one apertures for respective buttons on bar gun wherein the cover plate is configured to be installed on the bar gun and is shaped to coordinate with the access aperture.

5. The cover assembly of claim 2 wherein the cover assembly can transmit illumination throughout the cover assembly.

6. The cover assembly of claim 2 wherein the cover assembly can transmit illumination to the bar gun buttons.

7. The cover assembly of claim 2 wherein the cover assembly can transmit illumination to the bar gun nozzle.

8. The cover assembly of claim 2 wherein the cover assembly can transmit illumination to the dispensed beverage.

9. The cover assembly of claim 2 further comprising illumination.

10. The cover assembly of claim 5 wherein the illumination illuminates the cover assembly.

11. The cover assembly of claim 5 wherein the illumination illuminates the bar gun buttons.

12. The cover assembly of claim 5 wherein the illumination illuminates the bar gun nozzle.

13. The cover assembly of claim 5 wherein the illumination illuminates the dispensed beverage.
